(19) United States
(12) Patent Application Publication
(10) Pub. No.: US 2018/0310050 A1
(43) Pub. Date: Oct. 25, 2018

(54) STREAMING WITH SEAMLESS TRANSITIONS BETWEEN DEVICES

(71) Applicant: CRACKLE, INC., Culver City, CA (US)

(72) Inventors: Aaron Goldstein, Culver City, CA (US); Christine Coner, Culver City, CA (US); Ihor Yaskiw, Culver City, CA (US)

(21) Appl. No.: 15/495,608

(22) Filed: Apr. 24, 2017

(51) Int. Cl. H04N 21/436; H04N 21/41; H04N 21/472; H04N 21/45; H04N 21/442; H04N 21/4363

(52) U.S. Cl. CPC H04N 21/43615; H04N 21/4126; H04N 21/43637; H04N 21/4524; H04N 21/44227; H04N 21/47217

(57) ABSTRACT

Viewing a program and seamlessly transitioning between devices in multiple locations while enabling movement between the multiple locations, including: determining a parameter to be monitored to provide seamless transitions between a first device and a second device; monitoring the parameter against a preset threshold; receiving the program from a content provider; and routing the program to one of: the first device when the parameter is below the preset threshold; or the second device when the parameter is above the preset threshold.

### BACKGROUND

### Field of the Disclosure

The present disclosure relates to streaming programs, and more specifically, to streaming a program to multiple devices with seamless transitions between devices.

### Background

Conventional systems having multiple television sets or other media devices in different locations and streaming a program to all of the multiple sets or devices may enable a viewer moving from one location to another location to seamlessly watch the program. However, with these systems, the viewer may miss the program during the time the viewer is moving from one location to another location. Other conventional systems may provide a capability to pause or stop the program on a first device at one location and resume the playing of the same program on a second device at another location. However, in this configuration, the viewer needs to perform certain actions to pause the program on the first device and to search and resume the same program on the second device starting from where the program was left off.

### SUMMARY

The present disclosure provides for viewing a program and seamlessly transitioning between devices in multiple locations while enabling movement between the multiple locations.

In one implementation, a method is disclosed. The method includes: determining a parameter to be monitored to provide seamless transitions between a first device and a second device; monitoring the parameter against a preset threshold; receiving the program from a content provider; and routing the program to one of: the first device when the parameter is below the preset threshold; or the second device when the parameter is above the preset threshold.

In another implementation, a system for viewing a program and seamlessly transitioning between devices while enabling movement between multiple locations is disclosed. The system includes: a plurality of devices including a first device and a second device, the plurality of devices configured to be located within at least one of the multiple locations; and a parameter monitor configured to determine and monitor a parameter to be monitored to provide seamless transitions between the first device and the second device against a preset threshold, to receive the program from a content provider, and to route the program to one of: the first device when the parameter is below the preset threshold; or the second device when the parameter is above the preset threshold.

In a further implementation, an apparatus for viewing a program and seamlessly transitioning between devices in multiple locations while enabling movement between the multiple locations is disclosed. The apparatus includes: means for determining a parameter to be monitored to provide seamless transitions between a first device and a second device; means for monitoring the parameter against a preset threshold; means for receiving the program from a content provider; and means for routing the program to one of: the first device when the parameter is below the preset threshold; or the second device when the parameter is above the preset threshold.

Other features and advantages should be apparent from the present description which illustrates, by way of example, aspects of the disclosure.

### BRIEF DESCRIPTION OF THE DRAWINGS

The details of the present disclosure, both as to its structure and operation, may be gleaned in part by study of the appended drawings, in which like reference numerals refer to like parts, and in which:

FIG. 1 is an illustration showing the viewer watching the program in the first location on the first device streamed and/or downloaded from the content provider in accordance with one implementation of the present disclosure;

FIG. 2 is an illustration showing the viewer leaving the living room with the second device to prepare a sandwich in the kitchen;

FIG. 3 is an illustration showing the viewer viewing the program on the second device at the second location;

FIG. 4 is an illustration showing that the viewer has returned to the first location with the second device;

FIG. 5 is a flow diagram illustrating a process for viewing a program and seamlessly transitioning between multiple devices in multiple locations while enabling movement between the multiple locations in accordance with one implementation of the present disclosure;

FIG. 6 is a block diagram of a transition system for viewing a program and seamlessly transitioning between multiple devices in multiple locations while enabling movement between the multiple locations in accordance with one implementation of the present disclosure;

FIG. 7 is a block diagram of a transition system for viewing a program and seamlessly transitioning between multiple devices in multiple locations while enabling movement between the multiple locations in accordance with another implementation of the present disclosure; and

FIG. 8 is a block diagram of a parameter monitoring apparatus in accordance with one implementation of the present disclosure.

### DETAILED DESCRIPTION

As described above, configurations of an entertainment system which enable seamless viewing of a program in multiple locations can be a challenge. Conventional solutions may provide a capability to pause or stop the program on a first device at one location and resume the playing of the same program on a second device at another location. However, the viewer needs to perform actions to pause the program on the first device and to search and resume the same program on the second device starting from the point where the program was left off.

Certain implementations of the present disclosure provide alternative solutions for seamlessly viewing a program in multiple locations while enabling movement between the multiple locations. The term “seamless viewing” refers to the process of transitioning the viewing of a viewer from one device at one point in the program to the same one point in the same program on another device. In one implementation, parameters are monitored to determine when to transition between devices.

After reading these descriptions, it will become apparent how to implement the disclosure in various implementations and applications. However, although various implementations of the present disclosure will be described herein, it is understood that these implementations are presented by way of example only, and not limitation. As such, this detailed description of various implementations should not be construed to limit the scope or breadth of the present disclosure.

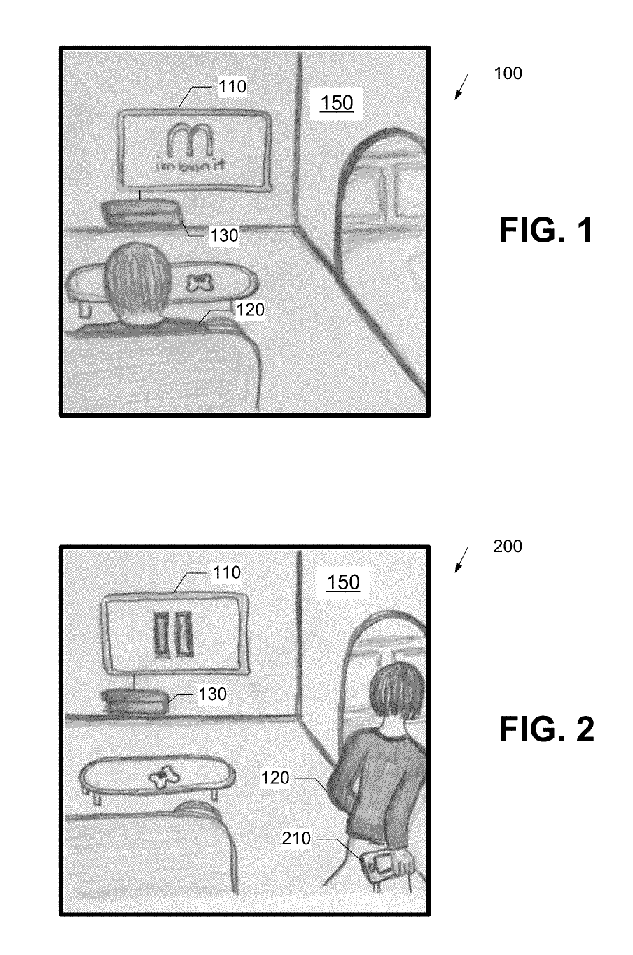

FIGS. 1 through 4 are illustrations 100, 200, 300, 400 of a transition process or system for viewing a program and seamlessly transitioning between multiple devices in multiple locations while enabling movement between the multiple locations in accordance with one implementation of the present disclosure. In one implementation, the transition process/system involves a parameter monitor 130 and at least a first device 110 and a second device 210 configured to receive the program from a content provider and to seamlessly transition the execution of the program between the first device 110 and the second device 210.

Initially, the viewer 120 is watching, for example, a food program on the first device 110 in the first location (e.g., the living room 150). In one implementation, the parameter monitor 130 requests the content provider to stream or download the program to the first device 110 (through, for example, a wifi connection) because the viewer 120 is located within the preset threshold (e.g., within the confines of the living room 150; e.g., 30 feet from the parameter monitor) of the parameter monitor 130 (or the first device 110). In one implementation, the viewer 120 being located within the present distance threshold is measure by the location of the second device 210 (e.g., a mobile device) which is in possession of the viewer 120. Thus, the parameter monitor 130 keeps the second device 210 in a hold state. The parameter monitor 130 determines whether the distance of the second device 210 from the parameter monitor 130 has increased above the preset threshold, because, for example, the viewer 120 watching the food program on the first device 110 has left the first location with the second device 210 to prepare a sandwich in a second location (e.g., the kitchen 250). The parameter monitor 130 then instructs the first device 110 to pause the program and requests the content provider to stream or download the program (through, for example, the wifi connection) to the second device 210 rather than the first device 110, when the parameter monitor determines that the distance of the second device 210 from the parameter monitor 130 has increased above the preset threshold. Therefore, the transition process running on the parameter monitor 130 seamlessly transitions the program from the first device 110 to the second device 210 so that the viewer 120 is able to view the program without interruption as the viewer moves from the living room (i.e., the first location) to the kitchen (i.e., the second location).

In one implementation, the parameter monitor 130 enables the viewer 120 to continue viewing the program on the second device 210 in the second location 250 since the second device 210 is outside of the preset distance threshold. When the viewer 120 decides to return to the first location with the second device 210 (e.g., after the viewer 120 has prepared the sandwich in the kitchen and is ready to return to the living room), and once the distance of the second device 210 decreases below the preset distance threshold, the parameter monitor 130 executes the transition process in reverse from the steps described above.

That is, when the parameter monitor 130 determines that the distance of the second device 210 from the parameter monitor 130 has decreased below the preset threshold (because, for example, the viewer 120 watching the program on the second device 110 has left the second location (e.g., the kitchen) with the second device 210 and has returned to the first location (e.g., the living room)), the parameter monitor 130 instructs the second device 210 to pause the program and requests the content provider to stream or download (through, for example, the wifi connection) the program to the first device 110 again. Therefore, the transition process running on the parameter monitor 130 seamlessly transitions the program from the second device 210 to the first device 110 so that the viewer 120 is able to view the program without interruption as the viewer 120 moves from the kitchen (i.e., the second location) to the living room (i.e., the first location).

FIG. 1 is an illustration 100 showing the viewer 120 watching the program in the first location 150 on the first device 110 streamed and/or downloaded from the content provider in accordance with one implementation of the present disclosure. In one implementation, the content provider is a streaming service such as Crackle™ or Netflix™. In another implementation, the first device 110 on which the program is viewed is a game console such as the PlayStation™ console.

FIG. 2 is an illustration 200 showing the viewer 120 leaving the first location (e.g., the living room) with the second device 210 (e.g., to prepare a sandwich in the second location (e.g., the kitchen)). In this case, the parameter monitor 130 instructs the first device 110 to pause the program and requests the content provider to stream or download the program to the second device 210 rather than the first device 110. Therefore, the transition process running on the parameter monitor 130 seamlessly transitions the program from the first device 110 to the second device 210 so that the viewer 120 is able to view the program without interruption as the viewer moves from the living room (i.e., the first location) to the kitchen (i.e., the second location).

In one implementation, upon leaving the first location, the parameter monitor 130 prompts the viewer 120 whether to continue streaming the program on the second device 210. Once the viewer 120 clicks to accept the prompt, the parameter monitor 130 initiates the seamless transition back into the program (e.g., by requesting the content provider to stream the program to the second device 210).

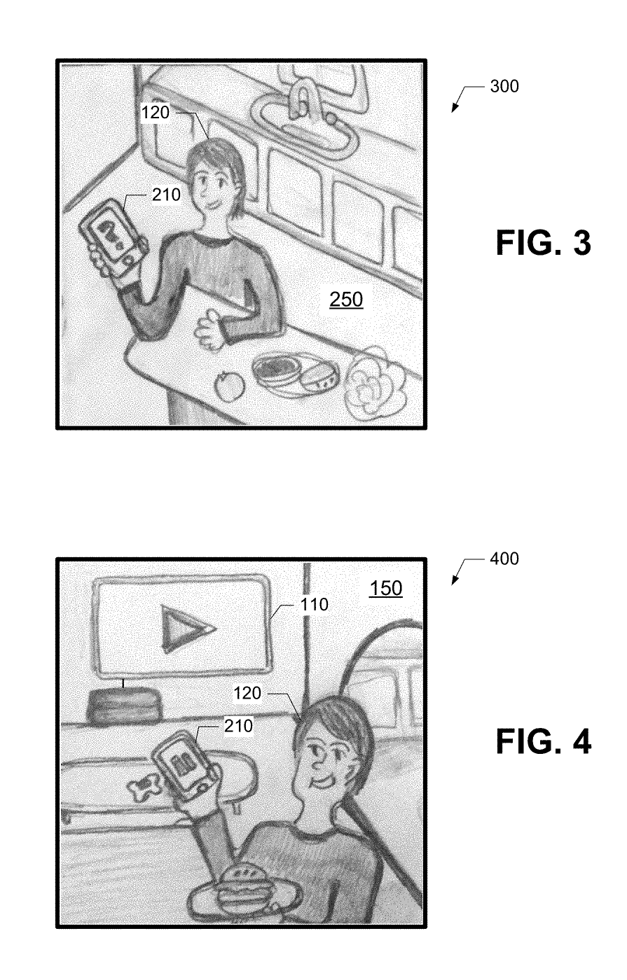

FIG. 3 is an illustration 300 showing the viewer 120 viewing the program on the second device 210 at the second location 250. The program is streamed or downloaded and the viewer 120 continues to view the program on the second device 210 in the second location 250, since the second device 210 is outside of the preset distance threshold.

FIG. 4 is an illustration 400 showing that the viewer 120 has returned to the first location 150 with the second device 210. In one implementation, as the viewer 120 returns to the first location 150 with the second device 210, the parameter monitor 130 determines that the distance of the second device 210 has decreased below the preset distance threshold. In this case, the parameter monitor 130 instructs the second device 210 to pause the program and requests the content provider to stream or download (through, for example, the wifi connection) the program to the first device 110 again.

In one implementation, upon returning to the first location, the parameter monitor 130 prompts the viewer 120 whether to stream the program on the first device 110. Once the viewer 120 clicks to accept the prompt, the parameter monitor 130 initiates the seamless transition back into the program (e.g., by requesting the content provider to stream the program to the first device 110).

In an alternative implementation for the parameter monitor 130, instead of requesting the content provider to stream or download the program to either the first or second device, the parameter monitor 130 may be configured to receive the program directly from the content provider. The parameter monitor 130 then determines whether the program is routed to the first 110 or second device 210.

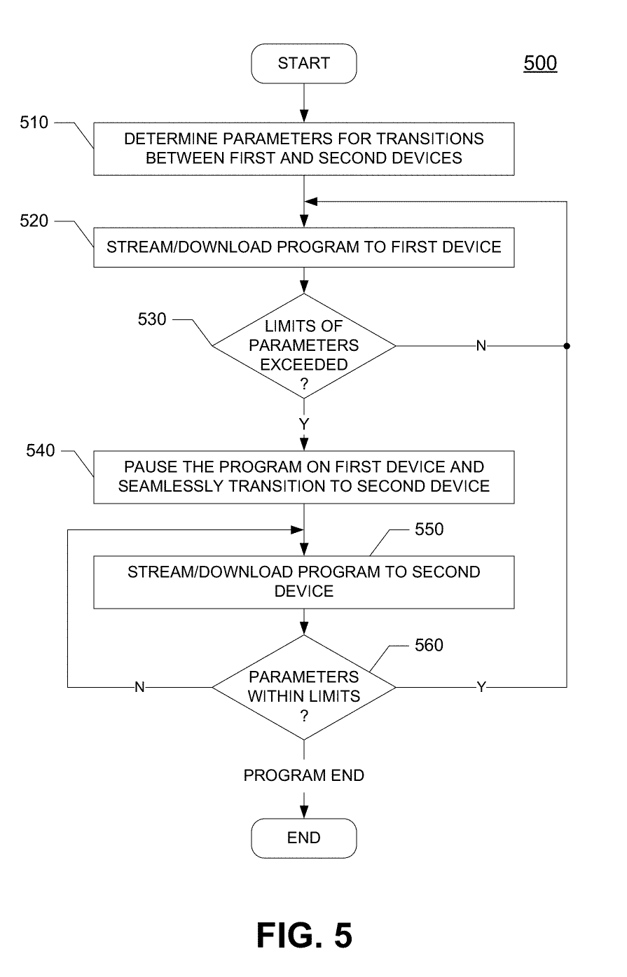

FIG. 5 is a flow diagram illustrating a process 500 for viewing a program and seamlessly transitioning between multiple devices in multiple locations while enabling movement between the multiple locations in accordance with one implementation of the present disclosure. In one implementation, the transition process involves monitoring parameter(s) to provide seamless transitioning of the execution of a program from a content provider between a first device and a second device. Initially, depending on the state of the parameters (e.g., the distance parameter), one of the devices is put in a pause state, while the program is downloaded to the other device.

In the illustrated implementation of FIG. 5, parameters used to provide seamless transitions between the first and second devices are determined, at block 510. In one example, one of the parameters monitored includes a relative distance between the parameter monitor 130 or first device 110 and the second device 210. Thus, in this example, the distance of the second device 210 from the parameter monitor 130 may be monitored, and a trigger or flag may be set or displayed when the distance increases above a preset threshold or decreases below the preset threshold. Accordingly, in one example, the first device 110 is in a first location, and when the viewer 120 leaves the first location with the second device 210, the distance of the second device 210 from the parameter monitor 130 (or first device 110) increases above the preset threshold.

At block 520, the program is streamed or downloaded to the first device at the first location. In one implementation, the process 500 requests the content provider to stream or download the program to the first device 110 since the second device 210 is located within the preset distance threshold without exceeding it. In an alternative implementation, the process 500 determines and routes the program to the first 110 or second device 210 depending on the relative distance of the first device 110 with respect to the second device 210.

Limits of the parameter(s) are checked, at block 530, to determine whether the limits are exceeded. If it is determined, at block 530, that the limits are not exceeded, then the process 500 returns to block 520 to continue streaming or downloading to the first device at the first location. Otherwise, if it is determined, at block 530, that the preset limits are exceeded, then the program is paused on the first device 110 and is transitioned to the second device 210, at block 540. Thus, when the process 500 determines that the distance of the second device 210 from the first device 110, for example, has increased above the preset threshold, because the viewer 120 has left the first location with the second device 210, the program is paused on the first device 110 and is started or resumed on the second device 210, at block 550, from the point where it was left off in the first device 110.

In one implementation, the process 500 enables the viewer 120 to continue viewing the program on the second device 210 in the second location 250 since the second device 210 is outside of the preset distance threshold (i.e., the parameter(s) continue to stay outside of the preset limits, at block 560). When the viewer 120 decides to return to the first location with the second device 210, and once the parameter(s) are back within the preset limit(s), as measured at block 560, the process 500 executes the transition process to stream or download the program back onto the first device 110, while pausing the second device 210.

In an alternative implementation, parameter(s) monitored by the process 500 or parameter monitor 130 may include a viewer selection. For example, the viewer may, for some reason, decide to watch the program (which, for example, is being watched on the first device 110) on another device (e.g., a third device) during the mid-stream. In this case, the process 500 or parameter monitor 130 may pause the program on the first device 110 and instruct the third device to resume or start the program from the point where the viewer was watching on the first device 110.

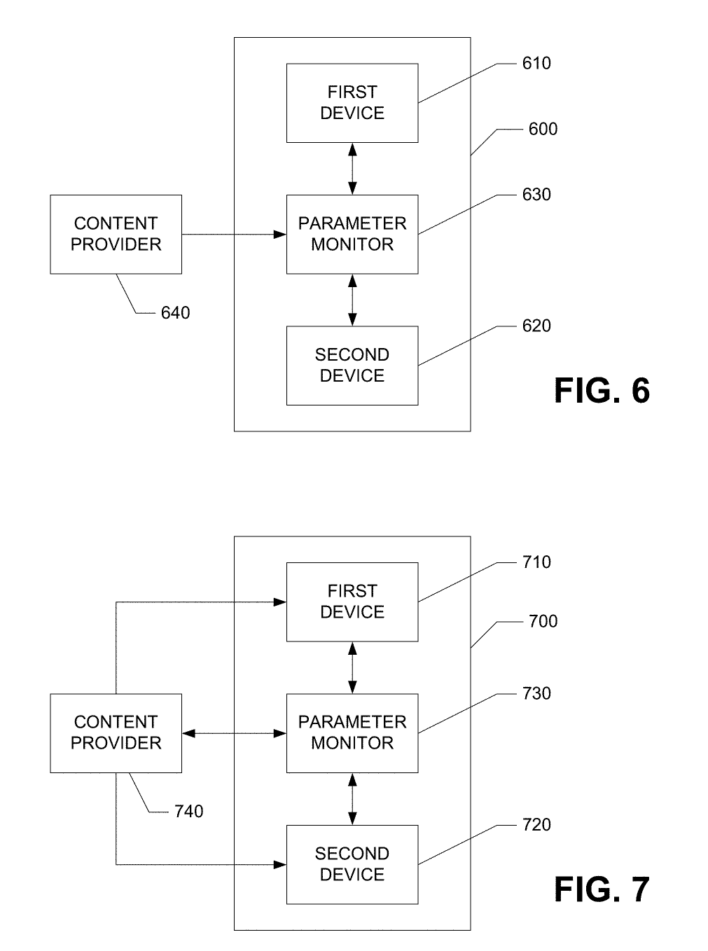

FIG. 6 is a block diagram of a transition system 600 for viewing a program and seamlessly transitioning between multiple devices in multiple locations while enabling movement between the multiple locations in accordance with one implementation of the present disclosure. In one implementation, the transition system 600 includes a plurality of device including at least a first device 610, a second device 620, and a parameter monitor 630.

In the illustrated implementation of FIG. 6, the viewer is viewing the program on the first device 610 in the first location. In one implementation, the parameter monitor 630 receives the program from the content provider 640 and routes the program to the first device 610 since the second device 620 is located within the preset threshold of the parameter monitor 630 (or the first device 610). Thus, the parameter monitor 630 keeps the second device 620 in a hold state. When the parameter monitor 630 determines that the distance of the second device 620 from the parameter monitor 630 has increased above the preset threshold, because, for example, the viewer watching the program on the first device 610 has left the first location with the second device 620 to the second location. The parameter monitor 630 then instructs the first device 610 to pause the program and routes the program received from the content provider 640 to the second device 620 rather than the first device 610. Therefore, the transition process running on the parameter monitor 630 seamlessly transitions the program from the first device 610 to the second device 620 so that the viewer is able to view the program without interruption as the viewer moves from the first location to the second location.

In one implementation, the parameter monitor 130 enables the viewer to continue viewing the program on the second device 620 in the second location since the second device 620 is outside of the preset threshold. When the viewer decides to return to the first location with the second device 620, and once the distance of the second device 620 from the parameter monitor 630 decreases below the preset threshold, the parameter monitor 630 executes the transition process in reverse from the steps described above.

In one implementation, the parameter monitor 630 is a stand-alone device that monitors the parameters of the first device 610 and the second device 620. In another implementation, the parameter monitor 630 is partially or wholly contained within the first 610 or second device 620. In another implementation, the parameter monitor 630 is wirelessly coupled to the first device 610 and the second device 620.

In one implementation, the parameter monitor 630 monitors the parameters of the first device 610 and the second device 620 with respect to each other. For example, one of the parameters monitored by the parameter monitor 630 includes a relative distance between the first device 610 and the second device 620. In one example, shown in FIG. 1, the first device 610 is a fixed device such as a flat screen television set and the second device is a mobile device. Thus, the parameter monitor 630 may monitor the distance of the second device 620 from the first device 610, and issue a trigger or flag when the distance increases above a preset threshold or decreases below the preset threshold. Accordingly, in one example, the first device 610 is in a first location, and when the viewer leaves the first location with the second device 620, the distance of the second device 620 from the first device 610 or parameter monitor 630 increases above the preset threshold.

FIG. 7 is a block diagram of a transition system 700 for viewing a program and seamlessly transitioning between multiple devices in multiple locations while enabling movement between the multiple locations in accordance with another implementation of the present disclosure. In one implementation, the transition system 700 includes a plurality of device including at least a first device 710, a second device 720, and a parameter monitor 730.

In the illustrated implementation of FIG. 7, when the parameter monitor 730 detects that the second device 720 has moved outside of (or moved back within) the preset threshold of the parameter monitor 730 (or the first device 710), the parameter monitor 730 requests the content provider 740 to transition the download or streaming of the program from one device to another, rather than receiving and routing the program itself, as in the implementation of FIG. 6.

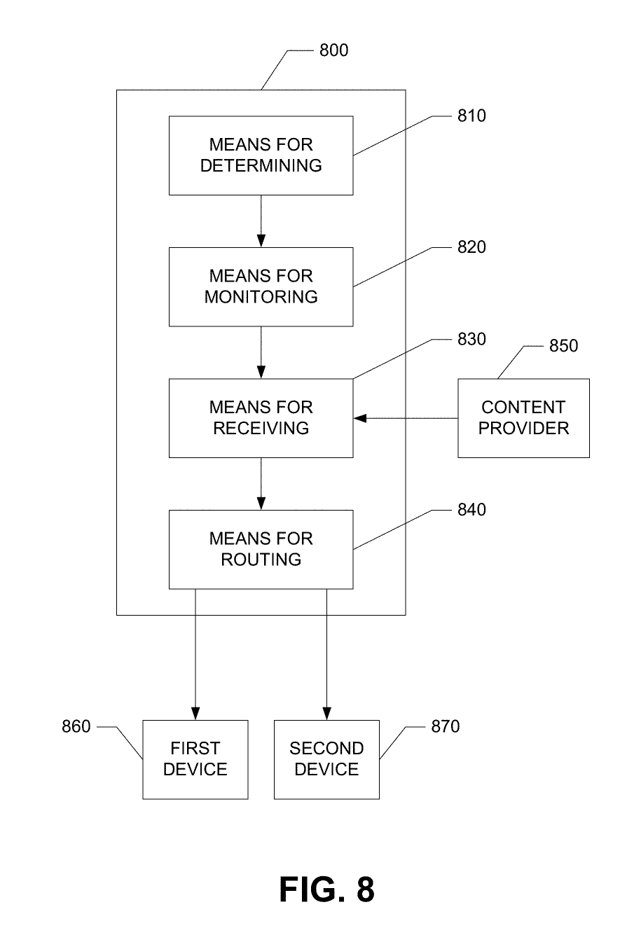

FIG. 8 is a block diagram of a parameter monitoring apparatus 800 in accordance with one implementation of the present disclosure. In the illustrated implementation of FIG. 8, the apparatus 800 includes: means for determining 810 a parameter to be monitored to provide seamless transitions between a first device 860 and a second device 870; means for monitoring 820 the parameter against a preset threshold; means for receiving 830 the program from a content provider 850; and means for routing 840 the program to one of: the first device 860 when the parameter is below the preset threshold; or the second device 870 when the parameter is above the preset threshold.

In one implementation, the means for determining a parameter to be monitored to provide seamless transitions between the first and second devices includes means for determining a need for transitioning the viewing of the program from one device to another device. For example, the need for transitioning may include a situation where the viewer moves away from a location where the first device is located with a second device. Thus, to detect this situation, the means for determining the need for transition may involve monitoring a relative distance between the first and second devices. Therefore, in this example, the distance of the second device from the first device may be monitored, and a trigger or flag may be set or displayed when the distance increases above a preset threshold or decreases below the preset threshold. In other examples, other parameters, such as an absolute position of the viewer (using, for example, a GPS receiver coupled to the viewer or a mobile device carried by the user), may be monitored and a display (that is registered with the means for determining) closest to the viewer may be instructed to seamlessly play the program that the viewer is watching. In this configuration, other detectors (other than the GPS receiver coupled to the viewer) may be used. For example, a detector (e.g., an infra-red detector) mounted on displays may monitor an identifier coupled to the viewer and seamlessly display the program the viewer is watching.

In another implementation, the means for determining a parameter to be monitored to provide seamless transitions between the first and second devices also includes means for receiving or determining a preset threshold. In one implementation, determining the preset threshold may be done in the process of determining the need by the means for determining a need for transitioning the viewing of the program from one device to another device. For example, during the process of determining the need for transitioning, it may be determined that when the viewer is at least one distance (e.g., 30 feet) away from one device, the viewer is not able to adequately view the program on that device and that the program should be transitioned to another device. Thus, the preset threshold may set at the one distance.

In one implementation, the means for monitoring the parameter against a preset threshold includes monitoring the parameter so that when the parameter crosses the preset threshold, a flag or warning is set or displayed. Thus, when the flag or warning is set or displayed, the program is paused on the first device and is seamlessly transitioned to the second device. That is, the program is started or resumed on the second device from the point where it was left off in the first device.

Additional variations and implementations are also possible. For example, the program can be data for various types of content or other data, such as movies, television, video, music, audio, games, etc. Accordingly, the specific examples discussed herein are not the only implementations within the scope of the new technology. In another example, the parameter monitor 130 is included in a wifi router which can route the program to the first device or the second device depending on the parameter monitored.

One implementation includes one or more programmable processors and corresponding computer system components to store and execute computer instructions, such as for viewing a program and seamlessly transitioning between multiple devices in multiple locations while enabling movement between the multiple locations.

The above description of the disclosed implementations is provided to enable any person skilled in the art to make or use the disclosure. Various modifications to these implementations will be readily apparent to those skilled in the art, and the generic principles described herein can be applied to other implementations without departing from the spirit or scope of the disclosure. Accordingly, the techniques are not limited to the specific examples described above. Thus, it is to be understood that the description and drawings presented herein represent a presently possible implementation of the disclosure and are therefore representative of the subject matter that is broadly contemplated by the present disclosure. It is further understood that the scope of the present disclosure fully encompasses other implementations that may become obvious to those skilled in the art and that the scope of the present disclosure is accordingly limited by nothing other than the appended claims.

1. A method for viewing a program and seamlessly transitioning between devices in multiple locations, the method comprising:
determining a parameter to be monitored to provide seamless transitions between a first device and a second device;
monitoring the parameter against a preset threshold;
receiving the program from a content provider; and
routing the program to one of:
the first device when the parameter is below the preset threshold; or
the second device when the parameter is above the preset threshold.

2. The method of claim 1, wherein the parameter includes a distance measure between the first device and the second device.

3. The method of claim 1, further comprising
setting the preset threshold to a fixed distance.

4. The method of claim 1, further comprising
pausing the program on the second device when the parameter is below the preset threshold.

5. The method of claim 1, further comprising
pausing the program on the first device when the parameter is above the preset threshold.

6. The method of claim 1, wherein receiving the program from the content provider comprises
streaming the program from the content provider to the first or second device.

7. The method of claim 1, wherein routing the program to the first device comprises
pausing the program on the second device and starting the program on the first device from a point in the program where the program was paused on the second device.

8. The method of claim 1, wherein routing the program to the second device comprises
pausing the program on the first device and starting the program on the second device from a point in the program where the program was paused on the first device.

9. A system for viewing a program and seamlessly transitioning between devices while enabling movement between multiple locations, the system comprising:
a plurality of devices including a first device and a second device, the plurality of devices configured to be located within at least one of the multiple locations; and
a parameter monitor configured to determine and monitor a parameter to be monitored to provide seamless transitions between the first device and the second device against a preset threshold, to receive the program from a content provider, and to route the program to one of: the first device when the parameter is below the preset threshold; or the second device when the parameter is above the preset threshold.

10. The system of claim 9, wherein the parameter includes a distance measure between the first device and the second device.

11. The system of claim 9, wherein the parameter monitor is a stand-alone device.

12. The system of claim 9, wherein the parameter monitor is partially or wholly included within the first or second device.

13. The system of claim 9, wherein the parameter monitor is wirelessly coupled to the first device and the second device.

14. The system of claim 9, wherein the first device is a fixed device including a television set and the second device is a mobile device.

15. An apparatus for viewing a program and seamlessly transitioning between devices in multiple locations while enabling movement between the multiple locations, the apparatus comprising:
means for determining a parameter to be monitored to provide seamless transitions between a first device and a second device;
means for monitoring the parameter against a preset threshold;
means for receiving the program from a content provider; and
means for routing the program to one of: the first device when the parameter is below the preset threshold; or the second device when the parameter is above the preset threshold.

16. The apparatus of claim 15, wherein the means for routing the program to the first device comprises
means for pausing the program on the second device and starting the program on the first device from a point in the program where the program was paused on the second device.

17. The apparatus of claim 15, wherein the means for routing the program to the second device comprises
means for pausing the program on the first device and starting the program on the second device from a point in the program where the program was paused on the first device.

18. The apparatus of claim 15, wherein the means for determining a parameter used to provide seamless transitions comprises
means for determining a need for transitioning the viewing of the program from the first device to the second device.

19. The apparatus of claim 15, wherein the means for monitoring the parameter against a preset threshold comprises
means for monitoring a relative distance between the first device and the second device.

20. The apparatus of claim 15, wherein the means for monitoring the parameter against a preset threshold comprises
means for monitoring an absolute position of the viewer.
